(19) United States
(12) Patent Application Publication
(10) Pub. No.: US 2017/0245507 A1
(43) Pub. Date: Aug. 31, 2017

(54) METHOD FOR PREPARING A BATTERED OR BREADED FOOD

(71) Applicant: Dow Global Technologies LLC, Midland, MI (US)

(72) Inventors: Jing Guo, Midland, MI (US); Elizabeth L. Diaz, Fishers, IN (US); Jorg Theuerkauf, Lake Jackson, TX (US)

(21) Appl. No.: 15/503,774

(22) PCT Filed: Aug. 18, 2015
(86) PCT No.: PCT/US2015/045594

§ 371 Date: Feb. 14, 2017

Related U.S. Application Data
(60) Provisional application No. 62/043,137, filed on Aug. 28, 2014.

(51) Int. Cl. A21D 2/18; A23L 5/10; A23L 29/262; A23P 20/12; A23L 7/157; A23L 29/212

(52) U.S. Cl. CPC A21D 2/188; A21D 2/186; A23L 7/157; A23L 29/212; A23L 29/262; A23P 20/12; A23L 5/11; A23V 2002/00

(57) ABSTRACT

A method of reducing oil and/or fat uptake of a fried food comprises the steps of: A) contacting food i) with a batter comprising starch and a cellulose ether or ii) with a breading composition comprising a cellulose ether or iii) first with a batter comprising starch and then with a breading composition comprising a cellulose ether, B) contacting the battered or breaded food obtained in step A) with an aqueous liquid being different from the batter and breading composition in step A), C) optionally freezing the battered or breaded food obtained in step B), and D) frying the battered or breaded food obtained in step B) or C).

### FIELD

The present application relates to a method for preparing a battered or breaded food and to a method for reducing oil and/or fat uptake when battered or breaded food is fried.

### INTRODUCTION

Fried foods commonly designates foods which are fried, typically deep-fried in oil, and includes food which is battered and fried, such as croquettes (a small cake of minced food, such as poultry, fish, mushroom, fruit or vegetables including potatoes, or cereals that is usually coated with bread crumbs or a layer of wheat flour and fried in deep fat), battered and fried vegetables, fish or meat like poultry, as well as food which is produced by kneading dough ingredients such as wheat flour, shaping the dough composition, and frying the shaped dough composition. Examples of the latter food include doughnuts, fried bread, fried noodles, and the like. Alternatively or in addition to battering, the food can be breaded, i.e., the food can be coated with a breading such as corn meal, cracker crumbs, bread crumbs and the like.

Fried foods are widely consumed in many countries but considered unhealthy due to their high fat content. Therefore, much effort is spent by the skilled artisans to reduce the fat content of fried foods.

Cellulose ethers are known for their ability to reduce oil uptake of fried foods. European Patent Application EP 2 253 217 relates to a dough composition which comprises at least an aqueous solution of a water-soluble cellulose ether which is getable during heating, and cereal crop powder. The water-soluble cellulose ether is methylcellulose, hydroxypropyl methylcellulose, hydroxyethyl methylcellulose or hydroxyethyl ethylcellulose. When deep-frying dough prepared from such composition, the oil uptake of the dough is reduced, as compared to dough that does not comprise a water-soluble cellulose ether.

The International Patent Application WO 2010/135272 teaches a further improvement of the use of cellulose ethers for reducing oil uptake of fried foods. WO 2010/135272 discloses a dry batter mix which comprises flour, at least one seasoning, optionally a leavening agent, and granulated or agglomerated methylcellulose or hydroxypropyl methylcellulose. Carboxymethyl cellulose serves as a binder for agglomerating the methylcellulose or hydroxypropyl methylcellulose. A batter is produced by the addition of water. The batter is contacted with food to prepare battered food and the battered food is fried. Battered and fried food wherein the batter comprises agglomerated methylcellulose exhibits about 10% less oil uptake than comparable battered and fried food wherein the batter comprises non-agglomerated methylcellulose.

The International Patent Application WO2014/052214 discloses another improvement of the use of cellulose ethers for reducing oil uptake of fried foods. WO2014/052214 discloses incorporation of a cellulose ether with a specific particle size into batter, preparing battered food using this batter and frying the battered food. The cellulose ether has a particle size distribution such that at least 10 volume percent of the cellulose ether particles have a particle length of less than 40 micrometers. Battered and fried food wherein the batter comprises a cellulose ether of the described particle size distribution exhibits about 4-16% less oil uptake than comparable battered and fried food wherein the batter comprises a cellulose ether that has less than 10 volume percent particles having a particle length of less than 40 micrometers.

Prior to applying batter to food, a foodstuff often will undergo a pre-dusting step where a dry farinaceous-based predust composition is applied to the foodstuff in order to achieve an improved adhesion of wet batter to the foodstuff. U.S. Pat. No. 4,778,684 discloses that improved freeze/thaw stability of batter coated, pre-fried microwaveable foodstuffs is achieved if the dry predust comprises more than 20% of a hydroxypropyl methylcellulose having a methoxyl content greater than 22% and a hydroxypropoxyl content of at least 5% by weight.

In view of the known huge health risks caused by over-consumption of oils and fats, there is a long-felt need to find further methods of reducing the oil uptake of fried foods. One object of the present invention is to find a method which does not require a step of agglomerating methylcellulose or hydroxypropyl methylcellulose with carboxymethyl cellulose. A preferred object of the present invention is to find a method which even further reduces the oil uptake of fried foods than the methods disclosed in the prior art.

### SUMMARY

One aspect of the present invention is a method for preparing a battered or breaded food, which comprises the steps of A) contacting food i) with a batter comprising starch and a cellulose ether or ii) with a breading composition comprising a cellulose ether or iii) first with a batter comprising starch and then with a breading composition comprising a cellulose ether, and B) contacting the battered or breaded food obtained in step A) with an aqueous liquid being different from the batter and breading composition in step A) and comprising at least 80 percent water, based on the total weight of the aqueous liquid.

Another aspect of the present invention is a method of reducing oil and/or fat uptake of a fried food, which comprises the steps of A) contacting food i) with a batter comprising starch and a cellulose ether or ii) with a breading composition comprising a cellulose ether or iii) first with a batter comprising starch and then with a breading composition comprising a cellulose ether, B) contacting the battered or breaded food obtained in step A) with an aqueous liquid being different from the batter and breading composition in step A) and comprising at least 80 percent water, based on the total weight of the aqueous liquid, C) optionally freezing the battered or breaded food obtained in step B), and D) frying the battered or breaded food obtained in step B) or C).

Yet another aspect of the present invention is a method of reducing oil and/or fat uptake of a fried food, which comprises the steps of incorporating a cellulose ether in a starch-containing food preparation, contacting the starch-containing food preparation with an aqueous liquid comprising at least 80 percent water, based on the total weight of the aqueous liquid, optionally freezing the food preparation, and frying the optionally frozen food preparation.

### DESCRIPTION OF EMBODIMENTS

Surprisingly, it has been found that the oil and/or fat uptake of a fried food can even be further reduced if a cellulose ether is incorporated into the food itself or into a batter or a breading composition of the food and the food is subsequently contacted with an aqueous liquid, preferably dipped into the aqueous liquid, before the food is fried.

In one embodiment of the invention food is contacted with a batter that comprises starch and a cellulose ether to form a coating on the food surface. In another embodiment a breading composition comprising a cellulose ether is applied to the surface of the food. In yet another embodiment food is first contacted with a batter that comprises starch and optionally a cellulose ether and then with a breading composition that comprises a cellulose ether. Optionally the food is treated with a pre-dusting composition before the food is contacted with an above-mentioned batter or breading composition. The pre-dusting composition typically contains flour, but optionally it also comprises a cellulose ether. These embodiments are described in more details further below. For further reducing the oil and/or fat uptake in the subsequent frying process, it is essential that the thus treated food is first contacted with an aqueous liquid, preferably dipped into the aqueous liquid, before the food is fried. This essential step is also described in more details further below. The cellulose ether has a cellulose backbone having β-1,4 glycosidically bound D-glucopyranose repeating units, designated as anhydroglucose units in the context of this invention.

Useful cellulose ethers are, for example, carboxy-C₁-C₃-alkyl celluloses, such as carboxymethyl celluloses; or carboxy-C₁-C₃-alkyl hydroxy-C₁-C₃-alkyl celluloses, such as carboxymethyl hydroxyethyl celluloses. If these cellulose ethers are used, they are preferably used in combination with an alkylcellulose, hydroxyalkyl cellulose or hydroxyalkyl alkylcellulose.

The cellulose ether preferably is an alkylcellulose, hydroxyalkyl cellulose or hydroxyalkyl alkylcellulose. This means that in the cellulose ether at least a part of the hydroxyl groups of the anhydroglucose units are substituted by alkoxyl groups or hydroxyalkoxyl groups or a combination of alkoxyl and hydroxyalkoxyl groups. Typically one or two kinds of hydroxyalkoxyl groups are present in the cellulose ether. Preferably a single kind of hydroxyalkoxyl group, more preferably hydroxypropoxyl, is present.

Preferred alkylcelluloses are methylcelluloses. Preferred alkyl hydroxyalkyl celluloses including mixed alkyl hydroxyalkyl celluloses are hydroxyalkyl methylcelluloses, such as hydroxyethyl methylcelluloses, hydroxypropyl methylcelluloses or hydroxybutyl methylcelluloses; or hydroxyalkyl ethylcelluloses, such as hydroxypropyl ethylcelluloses, ethyl hydroxyethyl celluloses, ethyl hydroxypropyl celluloses or ethyl hydroxybutyl celluloses; or ethyl hydroxypropyl methylcelluloses, ethyl hydroxyethyl methylcelluloses, hydroxyethyl hydroxypropyl methylcelluloses or alkoxy hydroxyethyl hydroxypropyl celluloses, the alkoxy group being straight-chain or branched and containing 2 to 8 carbon atoms. Preferred hydroxyalkyl celluloses are hydroxyethyl celluloses, hydroxypropyl celluloses or hydroxybutyl celluloses; or mixed hydroxylkyl celluloses, such as hydroxyethyl hydroxypropyl celluloses.

Particularly preferred cellulose ethers are those having a thermal flocculation point in water, such as, for example, methylcelluloses, hydroxypropyl methylcelluloses, hydroxyethyl methylcelluloses, ethylhydroxy ethylcelluloses, and hydroxypropyl celluloses. The cellulose ethers are preferably water-soluble, i.e., they have a solubility in water of at least 1 gram, more preferably at least 2 grams, and most preferably at least 5 grams in 100 grams of distilled water at 25° C. and 1 atmosphere.

Preferred are hydroxyalkyl alkylcelluloses, more preferred are hydroxyalkyl methylcelluloses and most preferred are hydroxypropyl methylcelluloses, which have an MS(hydroxyalkoxyl) and a DS(alkoxyl) described below. The degree of the substitution of hydroxyl groups of the anhydroglucose units by hydroxyalkoxyl groups is expressed by the molar substitution of hydroxyalkoxyl groups, the MS(hydroxyalkoxyl). The MS(hydroxyalkoxyl) is the average number of moles of hydroxyalkoxyl groups per anhydroglucose unit in the cellulose ether. It is to be understood that during the hydroxyalkylation reaction the hydroxyl group of a hydroxyalkoxyl group bound to the cellulose backbone can be further etherified by an alkylation agent, e.g. a methylation agent, and/or a hydroxyalkylation agent. Multiple subsequent hydroxyalkylation etherification reactions with respect to the same carbon atom position of an anhydroglucose unit yields a side chain, wherein multiple hydroxyalkoxyl groups are covalently bound to each other by ether bonds, each side chain as a whole forming a hydroxyalkoxyl substituent to the cellulose backbone. The term “hydroxyalkoxyl groups” thus has to be interpreted in the context of the MS(hydroxyalkoxyl) as referring to the hydroxyalkoxyl groups as the constituting units of hydroxyalkoxyl substituents, which either comprise a single hydroxyalkoxyl group or a side chain as outlined above, wherein two or more hydroxyalkoxy units are covalently bound to each other by ether bonding. Within this definition it is not important whether the terminal hydroxyl group of a hydroxyalkoxyl substituent is further alkylated, e.g. methylated, or not; both alkylated and non-alkylated hydroxyalkoxyl substituents are included for the determination of MS(hydroxyalkoxyl). Hydroxyalkyl alkylcellulose utilized in the present invention generally have a molar substitution of hydroxyalkoxyl groups of at least 0.05, preferably at least 0.08, more preferably at least 0.12, most preferably at least 0.15 and particularly at least 0.20. The molar substitution of hydroxyalkoxyl groups is generally up to 1.00, preferably up to 0.90, more preferably up to 0.70, most preferably up to 0.60, and particularly up to 0.50.

The average number of hydroxyl groups substituted by alkoxyl groups, such as methoxyl groups, per anhydroglucose unit, is designated as the degree of substitution of alkoxyl groups, DS(alkoxyl). In the above-given definition of DS, the term “hydroxyl groups substituted by alkoxyl groups” is to be construed within the present invention to include not only alkylated hydroxyl groups directly bound to the carbon atoms of the cellulose backbone, but also alkylated hydroxyl groups of hydroxyalkoxyl substituents bound to the cellulose backbone. Hydroxyalkyl alkylcelluloses utilized in this invention typically have a DS(alkoxyl) of at least 1.0, preferably at least 1.1, more preferably at least 1.2, and particularly at least 1.6. The DS(alkoxyl) typically is up to 2.5, preferably up to 2.4, more preferably up to 2.2, and particularly up to 2.05.

Most preferably the cellulose ether is a hydroxypropyl methylcellulose or hydroxyethyl methylcellulose having a DS(methoxyl) within the ranges indicated above for DS(alkoxyl) and an MS(hydroxypropoxyl) or an MS(hydroxyethoxyl) within the ranges indicated above for MS(hydroxyalkoxyl). The degree of substitution of alkoxyl groups and the molar substitution of hydroxyalkoxyl groups can be determined by Zeisel cleavage of the cellulose ether with hydrogen iodide and subsequent quantitative gas chromatographic analysis (G. Bartelmus and R. Ketterer, Z. Anal. Chem., 286 (1977) 161-190).

The most preferred cellulose ether is methylcellulose. The average number of hydroxyl groups substituted by methoxyl groups per anhydroglucose unit is designated as the degree of substitution of methoxyl groups (DS). The methylcellulose preferably has a DS of at least 1.20, more preferably at least 1.25, and most preferably at least 1.40. The DS is preferably up to 2.25, preferably up to 2.20, and most preferably up to 2.10.

The determination of the % methoxyl in methylcellulose is carried out according to the United States Pharmacopeia (USP 34). The values obtained are % methoxyl. These are subsequently converted into degree of substitution (DS) for methoxyl substituents. Residual amounts of salt have been taken into account in the conversion. A grade of methylcellulose that is available under the tradename METHOCEL SG or SGA (The Dow Chemical Company) is particularly preferred. It has enhanced gel strength. The methylcellulose having enhanced gel strength and its production is disclosed in U.S. Pat. No. 6,235,893.

The viscosity of a cellulose ether utilized in the present invention, such as an alkyl cellulose (like a methylcellulose), a hydroxyalkyl cellulose or a hydroxyalkyl alkylcellulose (like a hydroxyalkyl methylcellulose) is preferably at least 50 mPa·s, more preferably at least 200 mPa·s, even more preferably at least 400 mPa·s and most preferably at least 450 mPa·s, when measured as a 2 wt.-% solution in water at 25° C. using a Brookfield LV viscometer at 10 rpm with spindle LV-1. The viscosity is preferably up to 10,000 mPa·s, more preferably up to 7,000 mPa·s, even more preferably up to 1,000 mPa·s, and most preferably up to 750 mPa·s, when measured as a 2 wt.-% solution in water at 25° C. as indicated above.

The cellulose ether is typically incorporated in particulate form in a dry pre-dusting composition, a dry batter mix and/or a breading composition. Preferably the cellulose ether has a particle size distribution such that at least 10 volume percent, preferably at least 12 volume percent, more preferably at least 15 volume percent, and most preferably at least 17 volume percent, of the cellulose ether particles have a particle length LEFI of less than 40 micrometers. Typically the volume fraction of the cellulose ether particles having a particle length LEFI of less than 40 micrometers is up to 75 percent, more typically up to 60 percent and most typically up to 50 percent, based on the total volume of the cellulose ether particles. The cellulose ether particles having a particle length LEFI of less than 40 micrometers are designated hereafter as fine particles. International Patent Application WO2014/052214 describes the use of such cellulose ether particles for preparing battered and fried food with a reduced oil and/or fat uptake.

The dimensional parameters of the cellulose ether particles which are preferably utilized in the methods of the present invention can be determined using a high speed image analysis method which combines particle size and shape analysis of sample images. An image analysis method for complex powders is described in: W. Witt, U. Köhler, J. List, Current Limits of Particle Size and Shape Analysis with High Speed Image Analysis, PARTEC 2007. A high speed image analysis system is commercially available from Sympatec GmbH, Clausthal-Zellerfeld, Germany as dynamic image analysis (DIA) system QICPIC™. Use of a Dynamic Image Analysis DIA system QICPIC™ equipped with a RODOS dry powder disperser from Sympatec GmbH, Clausthal-Zellerfeld, Germany for a variety of powders is described in: W. Yu, K. Muteki, L. Zhang, and G. Kim, Prediction of Bulk Powder Flow Performance Using Comprehensive Particle Size and Particle Shape Distributions, JOURNAL OF PHARMACEUTICAL SCIENCES, VOL. 100, NO. 1, JANUARY 2011. The high speed image analysis system is useful for measuring and calculating a number of dimensional parameters of particles. Some of these parameters are listed below.

LEFI: The particle length LEFI is defined as the longest direct path that connects the ends of the particle within the contour of the particle. “Direct” means without loops or branches.

DIFI: The particle diameter DIFI is defined as the projection area of the particle divided by the sum of all lengths of the branches of the particle.

Elongation: The particle elongation is the ratio of the diameter DIFI and the length LEFI of a particle, as defined by the formula DIFI/LEFI.

EQPC: EQPC of a particle is defined as the diameter of a circle that has the same area as the projection area of the particle.

Feret Diameter: Feret Diameter is also known as the caliper diameter. The distance between two tangents on opposite sides of a particle profile, that are parallel to some fixed direction, is the Feret Diameter. If a particle has an irregular shape, the Feret diameter usually varies much more than with regularly shaped particles.

Minimal Feret Diameter (Fmin): The minimum distance between pairs of tangents to the particle projection in some fixed direction. The minimal Feret diameter is the smallest diameter after consideration of all possible orientations (from 0° to 180°). For irregularly shaped particle, Fmin can be significantly smaller than EQPC.

Maximal Feret Diameter (Fmax): The maximum distance between pairs of tangents to the particle projection in some fixed direction. The maximal Feret diameter is the largest diameter after consideration of all possible orientations (from 0° to 180°). Fmax can be significantly larger than EQPC.

Aspect ratio: The aspect ratio of a particle in the powder is the ratio of minimal to the maximal Feret diameter, Fmin/Fmax, and is another measure for the particle shape. Fmin/Fmax is between 0 and 1 for any particle.

Sphericity: The ratio of the perimeter of a circle that has the same area as the projection area of the particle, P_{EQPC}, to the perimeter of the real particle. Since the equivalent circle gives the smallest possible perimeter at a given projection area, the value of sphericity is between 0 and 1 for any particle. The smaller the value, the more irregular the shape of the particle.

The cellulose ether particles which are preferably utilized in the present invention generally have a median Equivalent projected Circle Diameter (EQPC 50,3) of up 110 micrometers, preferably up 95 micrometers, more preferably up to 80 micrometers, most preferably up to 72 micrometers, and in the most preferred embodiment up to 65 micrometers. Generally the EQPC 50,3 is 10 micrometers or more, typically 20 micrometers or more, more typically 30 micrometers or more, and most typically 40 micrometers or more. All particle size distributions, e.g., the EQPC, can be displayed and applied as number (0), length (1), area (2) and volume (3) distribution. The volume distribution is designated by the number 3 after the comma in the term “EQPC 50,3”. The median EQPC means that 50% of the particles in the particle size distribution have an EQPC that is smaller than the given value in μm (micrometers) and 50% of the particles have an EQPC that is larger. The designation 50 reflects the median value.

The volume of fine particles and fibrous particles in a powder sample is calculated from the median of the number distribution of the respective EQPC for fine particles and from the medians of the number distributions of the respective LEFI and DIFI for fibrous particles. Number distributions are calculated from the EQPC, DIFI and LEFI for each particle within the sample.

Fine Particles:

For the purpose of the present invention fine particles have a particle length LEFI of less than 40 micrometers and generally a particle length LEFI of at least 10 micrometers. The detection limit of the Dynamic Image Analysis DIA system QICPIC™ with a M7 optical system is 10 micrometers.

The volume of the fine particles in a given sample of a cellulose ether is calculated according to Equation 1

$$V = \frac{{π ( EQPC )}^{3}}{6} n , \qquad ( Equation 1 )$$

wherein V is the volume of fine particles, n is the number of fine particles in the sample and EQPC here is the median EQPC determined from the number particle size distribution of the fine particles.

Fibrous Particles

Fibrous particles, as generally understood by the skilled artisan, are typically particles characterized by irregular shape and length typically much larger than the diameter. Fibers can be straight or curved, thin or thick. Consequently, both shape and size information from the QICPIC™ is used to define the fibrous particles. For the purpose of the present invention particles are “fibrous” particles if they meet one of the following definitions I or II: I) particles with an elongation equal or less than 0.35, an aspect ratio of equal or less than 0.45, and a LEFI of equal or greater than 40 micrometers; or II) particles with an elongation equal or less than 0.35, an aspect ratio of greater than 0.45, a sphericity of less than 0.7 and a LEFI of equal or greater than 40 micrometers.

The volume of fibrous particles in a given sample of a cellulose ether can be calculated according to Equation 2

$$Vf = \frac{π}{4} {( DIFI )}^{2} {LEFIn}_{f} , \qquad ( Equation 2 )$$

wherein V_{f} is the volume of fibrous particles, n_{f} is the number of fibrous particles in the sample, DIFI is the median projection area of the particles divided by the sum of all lengths of the branches of the particles determined from the number particle size distribution of the fibrous particles and LEFI is the median particle length determined from the number particle size distribution of the fibrous particles.

The volume fraction of the fine particles is V/Vₜₒₜ, and the volume fraction of the fibrous particles is V_{f}/Vₜₒₜ, wherein V and V_{f} are the volumes of the fine particles and of the fibrous particles, as calculated above, and Vₜₒₜ is the total volume of the given sample of a cellulose ether. Since the densities of an individual fine particle and of an individual fibrous particle are essentially the same, the volume fractions essentially correspond to the weight fractions.

The cellulose ether particles which are preferably utilized in the methods of the present invention preferably have a volume fraction of fibrous particles of no more than 40%, more preferably no more than 30% and most preferably no more than 25%. Typically the cellulose ether particles have a volume fraction of fibrous particles of one percent or more. As indicated above, the fibrous particles have a LEFI of equal or greater than 40 micrometers. The fibrous particles preferably have a median LEFI of not more than 150 micrometers. The median LEFI of fibrous particles means that 50% of the particles in the fraction of fibrous particles of the particle size distribution have a LEFI that is smaller than the given value in μm (micrometers) and 50% of the particles have a LEFI that is larger, as calculated from the number particle size distribution.

The production of cellulose ethers is generally known in the art. Typically the production process involves activating the cellulose, for example by treatment with an alkali metal hydroxide, reacting the thus treated cellulose with an etherifying agent, and washing the cellulose ether to remove by-products. After the washing step the cellulose ether generally has a moisture content of from 30 to 60 percent, typically from 45 to 55 percent, based on the total weight of the moist cellulose ether. While the preferred washing liquor may depend on the specific type of cellulose ether, preferred washing liquors generally are water, isopropanol, acetone, methylethylketone or brine. More preferred washing liquors generally are water or brine. Cellulose ethers are generally washed at a temperature of from 20 to 120° C., preferably from 65 to 95° C. A solvent-moist, preferably a water-moist filter cake is obtained after washing and separating the cellulose ether from the washing liquor. The moist cellulose ether is usually obtained in the shape of moist granules, moist lumps and/or a moist paste. Preferably the moist cellulose ether is extensively comminuted to cellulose ether particles wherein at least 10 volume percent of the cellulose ether particles have a particle length LEFI of less than 40 micrometers as described above. For example, the moist cellulose ether can be comminuted in a device suitable for simultaneous drying and grinding. Comminuting processes for producing these cellulose ether particles are described in International Patent Application WO2014/052214 on pages 10-12.

Foods that are battered or breaded according to the method of the present invention include, for example, vegetables and vegetable products (including tofu, potatoes, onions, okra, broccoli, zucchini, carrot, eggplant, and cauliflower), meat and meat products (including hot dogs and chicken), fish and fish products (including fish filets, processed fish sticks, and shrimp), mushroom, dairy products (including cheese), fruit and fruit products (including plantains), confectionary products, and combinations thereof (including products like Monte Cristo sandwiches). The foods may be raw, pre-cooked or part-cooked before it is coated with batter or breading composition. The food may also be hot, ambient, chilled or frozen when coated.

In one embodiment of the method of preparing a battered or breaded food, the food is treated with a dry pre-dusting composition which preferably comprises an above described cellulose ether before the food is contacted with a batter and/or breading composition as described further below. Pre-dusting is particularly useful when moist food like meat is subsequently battered. The pre-dust absorbs surface moisture, and creates a conductive or cohesive surface for the following batter coating. Typically the pre-dusting composition comprises starch as the main component, e.g., in the form of modified or unmodified flours or starches, such as corn flour, corn starch, wheat flour, barley flour, or a flower described below as ingredient of a batter. The pre-dusting composition generally comprises 50 percent or more, preferably 75 percent or more, and more preferably 85 percent or more of starch, typically in the form of flour, based on the total weight of the pre-dusting composition. Typical flours are as described below for the batter. The amount of starch can be up to 100 percent, but generally it is up to 99 percent, preferably up to 98 percent, more preferably up to 95 percent, and most preferably up to 92 percent, based on the total weight of the pre-dusting composition. Preferably the amount of the cellulose ether is at least 1 percent, more preferably at least 2 percent, even more preferably at least 5 percent, and most preferably at least 8 percent, based on the total weight of the pre-dusting composition. The amount of the cellulose ether is preferably up to 40 percent, more preferably up to 25 percent, even more preferably up to 20 percent, and most preferably up to 15 percent, based on the total weight of the pre-dusting composition. Preferred cellulose ethers are described above. More preferably, a cellulose ether is used which has a particle size distribution such that at least 10 volume percent of the cellulose ether particles have a particle length LEFI of less than 40 micrometers, as described above. The dry pre-dusting composition may comprise one or more optional additives, such as seasonings and/or flavorants, typically in a total amount of up to 10 percent, more typically in a total amount of up to 5 percent, based on the total weight of the pre-dusting composition. Typical seasonings are as described below for the batter.

In one embodiment of the present invention food, which has optionally been treated with a dry pre-dusting composition as described above, is contacted with a batter that comprises starch and optionally an above-described cellulose ether to form a coating on the food surface. When the battered food is not contacted with a breading composition before frying, the batter comprises an above-described cellulose ether. When the battered food is contacted with a breading composition before frying, the inclusion of the above-described cellulose ether in the batter is optional. Typically the batter does not comprise a cellulose ether when the battered food is contacted with a breading composition before frying. The food has optionally been pre-dusted as described above. The starch may originate from various sources. Starch is contained in large amounts in such staple foods as potatoes, wheat, maize (corn), rice, and cassava (tapioca). Depending on the plant, starch generally contains 20 to 25% amylose and 75 to 80% amylopectin by weight. Preferably, the starch is in the form of flour, such as wheat flour, corn flour, rice flour, potato flour, tapioca flour, soy flour, oat flour, or barley flour.

The batter is preferably prepared from a dry batter mix which comprises flour, optionally cellulose ether particles, and optional additives, such as a seasoning, and/or a leavening agent. Preferred cellulose ethers are described further above. More preferably, the cellulose ether in the dry batter mix, if any, has a particle size distribution such that at least 10 volume percent of the cellulose ether particles have a particle length LEFI of less than 40 micrometers, as described above. If cellulose ether particles are included in the dry batter mix, the amount of cellulose ether particles is preferably at least 0.5 percent, preferably at least 1 percent, and more preferably at least 2 percent, and up to 20 percent, preferably up to 10 percent, and more preferably up to 5 percent, based on the total weight of the dry batter mix. Preferably the dry batter mix comprises a seasoning. Preferred seasonings are, for example, salt, pepper, garlic, onion, cumin, paprika or herbs. In one embodiment, the optional leavening agent is baking powder. In some embodiments, the batter further comprises at least one of cornmeal, powdered milk, or powdered egg. The amount of ingredients in the dry batter mix is readily determined by those skilled in the art.

The dry batter mix is preferably mixed with water to prepare a batter. The batter preferably has a viscosity of up to 1000 mPa·s, more preferably from 100 to 950 mPa·s, measured at 25° C. using a Brookfield Digital Viscometer using the RV-1 and LV-1 spindle at 10 rpm. Typically at least 1 weight part, more typically at least 2 weight parts, and most typically at least 2.5 weight parts of water are mixed with 1 weight part of dry batter mix. Typically up to 10 weight parts, more typically up to 7 weight parts, and most typically up to 4 weight parts of water are mixed with 1 weight part of dry batter mix. If a cellulose ether is present in the batter, the amount of cellulose ether generally is at least 0.1 percent, preferably at least 0.2 percent, more preferably at least 0.5 percent, and most preferably at least 1.0 percent of cellulose ether, based on the total weight of the batter. The amount of cellulose ether generally is up to 10 percent, preferably up to 7 percent, more preferably up to 5 percent, and most preferably up to 2.0 percent of cellulose ether, based on the total weight of the batter.

In one embodiment of the present invention food, which has optionally been treated with a dry pre-dusting composition and/or which has optionally been coated with a batter as described above, is contacted with a breading composition which comprises a cellulose ether. Breading is often liked by consumers as it provides a crisp texture to the fried food. Generally the breading composition comprises a starch as described above. The starch origins from typical ingredients of the breading composition, such as corn meal, wheat flour, enriched wheat flour or malted barley, whole wheat flour, rye flour, oat bran, corn flour, corn meal, rice flour or potato flour, cracker crumbs or bread crumbs, such as panko bread crumbs, or mixtures thereof. The breading composition generally comprises 50 percent or more, preferably 60 percent or more, more preferably 70 percent or more, and most preferably 80 percent or more of starch, based on the total weight of the breading composition. The amount of starch generally is up to 98 percent, typically up to 95 percent, and more typically up to 90 percent, based on the total weight of the breading composition.

Generally the amount of the cellulose ether in the breading composition is at least 1 percent, preferably at least 2 percent, more preferably at least 5 percent, even more preferably at least 10 percent, and most preferably at least 12 percent, based on the total weight of the breading composition. The amount of the cellulose ether is generally up to 50 percent, preferably up to 40 percent, more preferably up to 30 percent, even more preferably up to 20 percent, and most preferably up to 15 percent, based on the total weight of the breading composition. Preferred cellulose ethers are described above. More preferably, a cellulose ether is used which has a particle size distribution such that at least 10 volume percent of the cellulose ether particles have a particle length LEFI of less than 40 micrometers, as described above.

The breading composition may comprise water, for example 4 percent or more, 7 percent or more, or in some cases even 10 percent or more, and typically up to 40 percent, more typically up to 30 percent, and most typically up to 20 percent, based on the total weight of the breading composition. in addition, the breading composition may contain optional additives, for example milk products, such as milk solids, skim milk, buttermilk or butter; seasonings such as salt, pepper, herbs, and spices; flavoring agents, coloring agents and/or preservatives. Specific examples of optional ingredient are niacin, ferrous sulfate, thiamine mononitrate, riboflavin, folic acid, high fructose corn syrup, corn syrup, partially hydrogenated vegetable oil, such as soybean oil, cottonseed oil, canola oil and/or corn oils, yeast, sugar, honey, sesame and/or poppy seeds, molasses, wheat gluten, whey, soy flour, lactic acid, distilled vinegar, soy lecithin, dough conditioners, such as mono and diglycerides, sodium and/or calcium stearoyl lactylate; yeast nutrients, monocalcium phosphate, calcium sulfate, ammonium sulfate, calcium propionate or potassium sorbate.

The breading composition comprising a cellulose ether can be produced by blending a dry cellulose ether in particulate form with other components of the breading composition or by dissolving a cellulose ether in an aqueous liquid, such as water, and contacting the aqueous solution of the cellulose ether with other components of the breading composition. For example, an aqueous solution of the cellulose ether can be sprayed on the other components of the breading composition, typically followed by drying. The aqueous solution typically comprises at least 1 percent, more typically at least 2 percent, and typically up to 20 percent, more typically up to 10 percent of the cellulose ether, based on the total weight of the aqueous solution.

For further reducing the oil and/or fat uptake in the subsequent frying process, it is essential that the thus treated food is first contacted with an aqueous liquid, preferably sprayed with the aqueous liquid or more preferably dipped into the aqueous liquid, before the food is fried. The aqueous liquid comprises at least 80 percent, typically at least 85 percent, preferably at least 90 percent, more preferably at least 95 percent, and even more preferably at least 98 percent of water, based on the total weight of the aqueous liquid. Most preferably, the aqueous liquid substantially consists of water. The aqueous liquid may comprise minor amounts of other ingredients, for example seasonings such as salt, pepper, herbs, and spices, flavoring and/or coloring, agents, a cellulose ether as described above and/or an organic liquid, such as an alcohol like ethanol. However, their total amount is not more than 20 percent, typically not more than 15 percent, preferably not more than 10 percent, even more preferably not more than 5 percent, and most preferably not more than 2 percent, based on the total weight of the aqueous liquid. The aqueous liquid is preferably used cold, i.e., it should generally have a temperature that is not more than 20° C., preferably not more than 15° C., more preferably not more than 10° C., and most preferably not more than 5° C. The aqueous liquid will typically have a temperature of −4° C. or more, more typically −2° C. or more, even more typically 0° C., and most typically 1 or 2° C. or more. A temperature in the range of 0° C. to 10° C. is most convenient.

After the battered or breaded food has been contacted with the aqueous liquid as described above, it may be subjected to further treatments. In one embodiment the method further comprises freezing the food. In another embodiment, the method further comprises baking or deep frying the food, optionally after par-frying and/or freezing the food. In the industrial food production a food is commonly provided with a batter or breading composition and cooked or part-cooked by frying in a food factory to set the batter or breading composition. Part-cooking by frying is known as “par-frying”. The cooked or, usually part-cooked food is subsequently chilled or frozen and packaged for delivery to consumers. The cooked or part-cooked foods are then prepared for consumption by frying in fat and/or oil, or by oven baking.

The present invention also relates to a method of reducing oil and/or fat uptake of a fried food, which comprises the steps of: A) contacting food i) with a batter comprising starch and a cellulose ether or ii) with a breading composition comprising a cellulose ether or iii) first with a batter comprising starch and then with a breading composition comprising a cellulose ether, B) contacting the battered or breaded food obtained in step A) with an aqueous liquid being different from the batter and breading composition in step A) and comprising at least 80 percent water, based on the total weight of the aqueous liquid, C) optionally freezing the battered or breaded food obtained in step B), and D) frying the battered or breaded food obtained in step B) or C).

The present invention also relates to a method of reducing oil and/or fat uptake of a fried food, which comprises the steps of incorporating a cellulose ether as described above in a starch-containing food preparation, contacting the starch-containing food preparation with an aqueous liquid comprising at least 80 percent water, based on the total weight of the aqueous liquid, as described above, optionally freezing the food preparation, and frying the optionally frozen food preparation. The starch-containing food is preferably a shaped food preparation, such as French fried potatoes, hash brown potatoes, croquettes, potatoes crisps, poultry nuggets, fish sticks, or onion rings, which incorporates the above-described cellulose ether. Preferred starch-containing shaped food preparations are potato preparations such as mashed potatoes, French fried potatoes, or hash brown potatoes, which are potato preparations in which potato pieces are pan-fried after being shredded, julienned, diced or riced. The amount of cellulose ether particles in the starch-containing food preparation preferably is 0.1 percent or more, and more preferably 0.2 percent or more, and preferably up to 1 percent, more preferably up to 0.5 percent, based on the total weight of the starch-containing food preparation.

The term “frying the battered or breaded food” includes the step of cooking or part-cooking by frying to set the batter or breading composition, optionally followed by chilling or freezing, and/or a frying step before consumption. Surprisingly, it has been found that the battered or breaded food produced by the method of the present invention generally exhibits at least 20% less oil and/or fat uptake, typically even at least 25% less oil and/or fat uptake, more typically even at least 30% less oil and/or fat uptake, and in preferred embodiments even at least 35% less oil and/or fat uptake than comparable battered or breaded food which has not been subsequently contacted with an aqueous liquid before frying as described above.

Unless specified otherwise, the terms “fat”, “oil” and “fat and/or oil” are used interchangeably herein to refer to edible fats and/or oils of animal or plant origin. Examples of edible oils of plant origin include sunflower oil, rapeseed oil, maize oil, peanut oil (groundnut oil), sesame oil, soybean oil, and palm oil.

Use of the terms “comprising”, “comprises” and variations thereof are intended to be open-ended. Thus, elements, steps or features not expressly listed or described are not excluded.

Some embodiments of the invention will now be described in detail in the following Examples.

### EXAMPLES

Unless otherwise mentioned, all parts and percentages are by weight. In the Examples the following test procedures are used.

Determination of Methoxyl Content and Viscosity

The determination of % methoxyl in methylcellulose was carried out according to the United States Pharmacopeia (USP 34). The viscosity of the methylcellulose was measured as a 2 wt.-% solution in water at 25° C. using a Brookfield LV viscometer at 10 rpm with spindle LV-1.

Determination of the EQPC 50,3, the Volume Percentages of Fine Particles and of Fibrous Particles and the Median LEFI of Fibrous Particles

The cellulose ether particles were analyzed with a high speed image analyzer sensor QICPIC, Sympatec, Germany, with a dry disperser RODOS/L with an inner diameter of 4 mm and a dry feeder VIBRI/L and Software WINDOX5, Vers. 5.3.0 and M7 lens.

Methylcellulose DPM SG A7C

Methylcellulose which was commercially available from The Dow Chemical Company under the trademark METHOCEL™ SG A7C and had a methoxyl content of 30.1% and a viscosity of 625 mPa·s, measured as a 2 wt.-% solution in water at 25° C. was used to produce methylcellulose DPM SG A7C. The methylcellulose was moistened with water and subjected to a grinding and drying process according to the procedure described in International Patent Application WO2014/052214 to produce methylcellulose particles of which at least 10 volume percent have a particle length LEFI of less than 40 micrometers. These methylcellulose particles are designated as “Methylcellulose DPM SG A7C” or “DPM SG A7C”.

The ground and dried MC had these particle sizes: EQPC 50,3: 56 μm; Vol. % V of fine particles 19; Vol. % Vf of fibrous particles 13; and median LEFI of fibrous particles, 118 μm.

Production of Battered and Breaded Food

Additional components of the compositions for pre-dusting, battering and breading as listed in Table 1 below were:

AP Flour (all purpose flour) ingredients: bleached wheat flour, malted barley flour, niacin, iron, thiamin mononitrate, riboflavin and folic acid.

Starch batter ingredients: Wheat flour (16%), natural corn starch Hylon VII (16%), rice flour (2.5%), salt (0.5%) and water (65%).

Breader ingredients (Meijer plain breader): enriched wheat flour, malted barley, niacin, ferrous sulfate, thiamine mononitrate, riboflavin, folic acid, water, high fructose corn syrup, corn syrup and partially hydrogenated vegetable oils.

Chicken pieces of uniform size and temperature were first pre-dusted with a pre-dusting composition as listed in Table 1 below and then coated with a batter and subsequently with a breading composition as listed in Table 1 below. Pre-dusting, battering and breading of the chicken pieces was done in 3 separate mixing bowls comprising the pre-dusting composition, the batter and the breading composition, respectively to which all chicken pieces were added together to achieve the same conditions for all chicken pieces. Per 100 g of chicken pieces 6 to 10 g of the pre-dusting composition, 10 to 20 g of the batter and 8 to 13 g of the breading composition were used. After the breading step, the chicken pieces of Example 1 were dipped in ice water for 3 to 8 seconds. Subsequently the chicken pieces of Example 1 were fried as described below. The chicken pieces of Comparative Examples A and B were directly fried as described below, without dipping them in ice water.

Frying Procedure

A commercial deep-fat fryer was used for the frying tests. The fryer was preheated prior to frying experiments until it reached 185° C. The battered and breaded chicken pieces produced as described above were submerged in a frying basket and par-fried for 25 to 30 seconds. The par-fried chicken pieces in the frying basket were removed from oil and shaken about ten times to remove the excess oil from the surface of the chicken pieces. Then the par-fried chicken pieces were transferred to a tared baking sheet and their final weight was recorded. Both baking sheet and chicken pieces were placed without covering in a freezer for 10 minutes, after which these were covered with plastic wrap (SARAN™ PVdC). Once the chicken pieces had been frozen overnight, the fryer was heated to 185° C. The baking sheet containing par-fried chicken pieces was placed on a scale and tared. Then the chicken pieces were placed into a submerged frying basket. The initial temperature was recorded. Finish-frying lasted about 4 minutes. The frying basket was removed from oil and shaken about ten times. The final temperature was recorded. The chicken pieces were transferred to a plastic bag (Ziploc™ bag) after cooling. The chicken pieces were frozen prior to oil analysis.

Oil Uptake Analysis

Oil content of the deep-fried chicken pieces was determined on dried samples using the Soxtec extraction method applying the principles described in Official Methods of Analysis of AOAC International, AOAC Official Method 2003.05 (Crude Fat in Feeds, Cereal Grains and Forages, Randall/Soxtec/Diethylether Extraction-Submersion Method, First Action 2003, Final Action 2006). A Soxtec 2055 Fat Extraction System was used which is commercially available from FOSS, Denmark applying the procedure described by FOSS in Application Sub Note ASN 3171 of 2005-03-01, revision 4.1. “Extraction of fat in Potato chips and Corn Snacks using Soxtec extraction systems”. The solvent used for oil extraction was Petroleum Ether 35/60, ACS, which is commercially available from Alfa Aesar, a Johnson Matthey Company.

The extracted oil was calculated, based on the total weight of the chicken pieces. The percentage of oil is based on the total weight of the chicken pieces, including the pre-dusting composition, batter, breading composition and oil.

Table 1 below lists the oil content of pre-dusted, battered and breaded chicken pieces of Example 1 that had been dipped in ice water after breading as described above and the oil content of pre-dusted, battered and breaded chicken pieces of Comparative Examples A and B that were not dipped in ice water after breading.

TABLE 1

| | | | | Dipping | Oil |
|---|---|---|---|---|---|
| (Comp.) | Pre-dusting | | | after | content |
| Example | composition | batter | Breading composition | breading | [%] |
| A | AP flour | yes | Meijer breader | No | 9.92 |
| B* | 90 parts AP flour + 10 | yes | 85 parts Meijer breader + | No | 7.57 |
| | parts DPM SG A7C | | 15 parts DPM SG A7C | | |
| 1 | 90 parts AP flour + 10 | yes | 85 parts Meijer breader + | Ice water | 4.65 |
| | parts DPM SG A7C | | 15 parts DPM SG A7C | | |

*Comparative Example, but not prior art

Table 1 above illustrates that the method of the present invention is surprisingly effective in reducing the oil uptake of fried foods. The battered and breaded chicken pieces of Comparative Example A, which neither contained a cellulose ether in the pre-dusting composition nor in the batter or nor in the breading composition, had an oil content of 9.92% after frying. The battered and breaded chicken pieces of Comparative Example B, which contained a cellulose ether in the pre-dusting composition and in the breading composition but was not contacted with an aqueous liquid such as ice water between breading and frying, had an oil content of 7.57%. The battered and breaded chicken pieces of Example 1, which contained a cellulose ether in the pre-dusting composition and in the breading composition and which was additionally contacted with ice water between breading and frying, had an oil content of only 4.65%. Example 1 has an oil uptake which is reduced by 38.6%, as compared to the battered food of Comparative Example B (100[7.57−4.65]/7.57). It is highly surprising that a simple dipping in cold water has such a large effect in reducing the oil uptake in the frying process of battered or breaded food. It should be noted that Comparative Example B is a Comparative Example, but not prior art. Example 1 has an oil uptake which is even reduced by 53%, as compared to the battered food of Comparative Example A (100×[9.92−4.65]/9.91).

1. A method for preparing a battered or breaded food, comprising the steps of
A) contacting food i) with a batter comprising starch and a cellulose ether or ii) with a breading composition comprising a cellulose ether or iii) first with a batter comprising starch and then with a breading composition comprising a cellulose ether, and
B) contacting the battered or breaded food obtained in step A) with an aqueous liquid consisting of 80 to 100 percent water and 0 to 20 percent of an ingredient selected from seasonings, flavoring agents, coloring agents and organic liquids, based on the total weight of the aqueous liquid.

2. The method of claim 1 wherein the aqueous liquid used in step B) comprises at least 90 percent of water, based on the total weight of the aqueous liquid.

3. The method of claim 1 wherein the aqueous liquid used in step B) has a temperature of 0 to 10° C. when it is contacted with the battered or breaded food obtained in step A).

4. The method of claim 1 wherein the food is treated with a dry pre-dusting composition comprising a cellulose ether before the food is subjected to step A).

5. The method of claim 4 wherein the dry pre-dusting composition comprises a cellulose ether having a particle size distribution such that at least 10 volume percent of the cellulose ether particles have a particle length LEFI of less than 40 micrometers.

6. The method of claim 1 wherein the batter comprising a cellulose ether has been produced from a dry batter mix comprising starch and a cellulose ether having a particle size distribution such that at least 10 volume percent of the cellulose ether particles have a particle length LEFI of less than 40 micrometers.

7. The method of claim 1 wherein the breading composition comprising a cellulose ether is producible by blending a dry cellulose ether in particulate form with other components of the breading composition or by dissolving a cellulose ether in an aqueous liquid and contacting the aqueous solution of the cellulose ether with other components of the breading composition.

8. The method of claim 7 wherein the cellulose ether has a particle size distribution such that at least 10 volume percent of the cellulose ether particles have a particle length LEFI of less than 40 micrometers.

9. The method of claim 1 wherein the cellulose ether is a methylcellulose or a hydroxyalkyl methylcellulose.

10. The method of claim 9 wherein the cellulose ether is methylcellulose.

11. The method of claim 1 further comprising the step of
C) freezing the battered or breaded food obtained in step B).

12. The method of claim 1 further comprising the step(s) of
C) optionally freezing the battered or breaded food obtained in step B), and
D) frying the battered or breaded food obtained in step B) or C).

13. A method of reducing oil and/or fat uptake of a fried food, comprising the steps of:
A) contacting food i) with a batter comprising starch and a cellulose ether or ii) with a breading composition comprising a cellulose ether or iii) first with a batter comprising starch and then with a breading composition comprising a cellulose ether,
B) contacting the battered or breaded food obtained in step A) with an aqueous liquid consisting of 80 to 100 percent water and 0 to 20 percent of an ingredient selected from seasonings, flavoring agents, coloring agents and organic liquids, based on the total weight of the aqueous liquid,
C) optionally freezing the battered or breaded food obtained in step B), and
D) frying the battered or breaded food obtained in step B) or C).

14. The method of claim 13 wherein battered or breaded food that has been subjected to steps A), B) and optionally C) exhibits at least 20% less oil and/or fat uptake in step D) than battered or breaded food that has been subjected to step A) and optionally C).

15. A method of reducing oil and/or fat uptake of a fried food, comprising the steps of incorporating a cellulose ether in a starch-containing food preparation, contacting the starch-containing food preparation with an aqueous liquid consisting of 80 to 100 percent water and 0 to 20 percent of an ingredient selected from seasonings, flavoring agents, coloring agents and organic liquids, based on the total weight of the aqueous liquid, optionally freezing the food preparation, and frying the optionally frozen food preparation.
